(19) United States
(12) Patent Application Publication
(10) Pub. No.: US 2026/0358943 A1
(43) Pub. Date: Nov. 12, 2026

(54) SYSTEMS AND METHODS FOR ADJUSTING CHARACTERISTICS OF A SIMULATED ELECTRONIC DEVICE

(71) Applicant: Warner Bros. Discovery, Inc., New York, NY (US)

(72) Inventors: Coplin LeBleu, Glendale, CA (US); Daniel Battista, Los Angeles, CA (US)

(21) Appl. No.: 19/202,200

(22) Filed: May 8, 2025

(51) Int. Cl. G06F 3/04847; G06F 3/04845

(52) U.S. Cl. CPC G06F 3/04847; G06F 3/04845

(57) ABSTRACT

Systems and methods for controlling one or more characteristics of a simulated device are disclosed. One computer-implemented method may include: establishing a wireless communication link between an operator device and the simulated device, wherein the simulated device includes one or more characteristics corresponding to a configuration of the simulated device; initiating an operator interface on the operator device, wherein the operator interface is configured to control the one or more characteristics of the simulated device; receiving one or more control commands from an operator of the operator device at an operator interface; transmitting, responsive to the receiving, the one or more control commands from the operator device to the simulated device via the wireless communication link; and updating, responsive to the transmitting, one or more configurations of the simulated device based on the one or more control commands.

### TECHNICAL FIELD

Various embodiments of the present disclosure relate generally to on-set media production, and, more particularly, to systems and methods for simulating device interfaces, controlling playback, and enabling dynamic interaction with device elements during filming.

### BACKGROUND

Media productions (e.g., television (TV) and film productions) frequently rely on the use of mobile devices on-screen, necessitating the display of specific content such as incoming calls, text messages, and application interactions in a controlled and realistic manner. Traditional methods, including the use of real mobile devices and pre-recorded content, suffer from various limitations. For instance, one challenge is the lack of real-time control, as real phone calls or pre-recorded sequences lack real-time adjustability and may introduce inconsistencies due to network connectivity issues. Many existing solutions also may not allow for dynamic customization of device user interface (UI) elements, reducing the flexibility needed for different production scenarios. In view of these challenges, a need exists for a software solution that enables seamless control over mobile device simulations during media production.

The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, systems and methods are disclosed for dynamically adjusting characteristics of a simulated device.

In one aspect, a computer-implemented method for controlling one or more characteristics of a simulated device is disclosed. The computer-implemented method may include operations including: establishing, by one or more processors, a wireless communication link between an operator device and the simulated device, wherein the simulated device includes one or more characteristics corresponding to a configuration of the simulated device; initiating, by the one or more processors, an operator interface on the operator device, wherein the operator interface is configured to control the one or more characteristics of the simulated device; receiving, by the one or more processors, one or more control commands from an operator of the operator device at an operator interface; transmitting, by the one or more processors and responsive to the receiving, the one or more control commands from the operator device to the simulated device via the wireless communication link; and updating, by the one or more processors and responsive to the transmitting, one or more configurations of the simulated device based on the one or more control commands.

In another aspect, a system for controlling one or more characteristics of a simulated device is disclosed. The system may include: a memory including instructions; and at least one processor configured to execute the instructions stored in the memory to perform operations including: establishing a wireless communication link between an operator device and the simulated device, wherein the simulated device includes one or more characteristics corresponding to a configuration of the simulated device; initiating an operator interface on the operator device, wherein the operator interface is configured to control the one or more characteristics of the simulated device; receiving one or more control commands from an operator of the operator device at an operator interface; transmitting, responsive to the receiving, the one or more control commands from the operator device to the simulated device via the wireless communication link; and updating, responsive to the transmitting, one or more configurations of the simulated device based on the one or more control commands.

In yet another aspect, a non-transitory computer-readable medium storing computer-executable instructions is disclosed. The non-transitory computer-readable medium, when executed by a server in network communication with at least one database, may cause the server to perform operations including: establishing, by one or more processors, a wireless communication link between an operator device and the simulated device, wherein the simulated device includes one or more characteristics corresponding to a configuration of the simulated device; initiating, by the one or more processors, an operator interface on the operator device, wherein the operator interface is configured to control the one or more characteristics of the simulated device; receiving, by the one or more processors, one or more control commands from an operator of the operator device at an operator interface; transmitting, by the one or more processors and responsive to the receiving, the one or more control commands from the operator device to the simulated device via the wireless communication link; and updating, by the one or more processors and responsive to the transmitting, one or more configurations of the simulated device based on the one or more control commands.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary block diagram of a computer system that supports a device simulation platform used in media production, according to one or more aspects of the present disclosure.

FIG. 2 depicts an exemplary workflow for utilizing an operator interface to manipulate characteristics on a simulated device, accordingly to one or more aspects of the present disclosure.

FIG. 3 provides an illustration of an exemplary operator interface for controlling a simulated device in a media production environment, according to one or more aspects of the present disclosure.

FIG. 4 provides an illustration of an exemplary operator interface for controlling aspects of a lock screen on a simulated device in a media production environment, according to one or more aspects of the present disclosure.

FIG. 5 provides an illustration of an exemplary operator interface for an incoming call simulation on a simulated device in a media production environment, according to one or more aspects of the present disclosure.

FIG. 6 provides an illustration of an exemplary operator interface for managing an active call on a simulated device in a media production environment, according to one or more aspects of the present disclosure.

FIG. 7 provides an illustration of an exemplary operator interface for managing correction controls for a simulated device in a media production environment, according to one or more aspects of the present disclosure.

FIG. 8 provides an illustration of an exemplary operator interface for managing visual effects (VFX) for a simulated device in a media production environment, according to one or more aspects of the present disclosure.

FIG. 9 provides an illustration of an exemplary operator interface that includes a live feed of the simulated device screen, according to one or more aspects of the present disclosure.

FIG. 10 provides an exemplary workflow for using one or more trained machine-learning models to manipulate characteristics on a simulated device, according to one or more aspects of the present disclosure.

FIG. 11 depicts an example computing system, according to one or more aspects of the present disclosure.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially” and “generally,” are used to indicate a possible variation of ±10% of a stated or understood value.

The term “user”, “subscriber,” and the like generally encompasses consumers who are subscribed to a streaming service (e.g., streaming platform) associated with the system described herein. The term “streaming service” (e.g., streaming platform) may refer to subscription-based video-on-demand (SVoD) services such as television shows, films, documentaries, and the like. The term “user” may be used interchangeably with “user profile,” “profile,” and the like throughout this application. The phrase “registered with” may be used interchangeably with “subscribed to” and the like throughout this application. The phrase “multimedia content” may be used interchangeably with “multimedia content item,” “article of multimedia content,” and the like throughout this application.

In media productions (e.g., such as in TV and film) mobile devices frequently appear on-screen, relying on the display of specific content such as incoming calls, text messages, application interactions, and other user interface elements. Ensuring that these on-screen interactions appear seamless and realistic is important to maintaining the authenticity of a scene. However, conventional methods for achieving this have been plagued by significant limitations. One common approach has been the use of real mobile devices, where production teams manually trigger calls or text messages. However, this method lacks real-time control, as it is often dependent on network connectivity, which may be unreliable, especially in remote filming locations. Additionally, productions have attempted to use pre-recorded content played back on devices, but this approach is rigid and inflexible, making it difficult to accommodate last-minute script changes or actor improvisations.

Other conventional attempts may include using casting technology or video playback software to display pre-rendered content on mobile device screens. However, these methods generally offer one-way communication, meaning that the production team has no real-time feedback from the device to ensure that the content is displayed correctly. Additionally, these solutions often lack interoperability across different operating systems, particularly between iOS and Android, making it challenging to provide a consistent experience across various devices. Furthermore, customization options may be typically limited, preventing productions from dynamically modifying UI elements such as time, date, wallpaper, or contact information, which are often necessary to align with the storyline.

To address the above-noted challenges, the present disclosure provides a software-based device simulation and control system specifically designed for on-set media production. This system enables seamless real-time control over device interactions, allowing operators to remotely trigger incoming calls, text messages, and application events with precise timing. Unlike pre-recorded playback solutions, this system may be configured to support dynamic updates, enabling last-minute modifications without the need for extensive reprogramming. The software may be designed to be platform-agnostic, working across iOS and Android devices while bypassing native operating system constraints to offer a fully customizable UI.

By leveraging Open Sound Control (OSC) and Wi-Fi-based two-way communication, the novel system may ensure that operators receive real-time feedback from the device, confirming whether commands have been successfully executed. This eliminates the guesswork and need for direct line-of-sight monitoring, streamlining production workflows. Additionally, the integration of Bluetooth controllers and external inputs allows for both automated and manually operated interactions, ensuring that the on-screen content can adapt dynamically to changes in the script or actor performance. Furthermore, the system supports real-time video monitoring through Network Device Interface (NDI), allowing production teams to verify on-screen displays remotely. By combining real-time interactivity, customizable UI elements, cross-platform compatibility, and operator-driven or automated control mechanisms, this novel system overcomes the major shortcomings of conventional solutions. It provides a flexible, efficient, and legally compliant method for incorporating mobile device interactions into media production, ultimately improving the realism and efficiency of on-set playback operations.

The concepts described herein represent a significant technical improvement in the field of on-set playback technology for TV and film production by introducing a real-time, interactive device simulation system that overcomes the limitations of conventional solutions. Specifically, the novel system is not merely an abstract automation of human activity, but rather, involves novel, non-generic technical features such as cross-platform mobile OS simulation, dynamic UI customization, and real-time video monitoring. These elements rely on a specific combination of software architecture, network communication protocols, and user interface design that fundamentally alters how devices are controlled and integrated into film production. Additionally, unlike traditional approaches that rely on pre-recorded content or manual trigger of real mobile devices, this system enables seamless two-way communication between an operator and the simulated device, ensuring precise control over on-screen interactions. By leveraging OSC and Wi-Fi based communication, the novel concepts enhance real-time responsiveness and reliability, eliminating the dependence on external network conditions or telecommunications infrastructure. This represents a fundamental shift from conventional one-way playback solutions, which provide no mechanism for feedback, making it difficult to verify whether content has been displayed correctly on a device during filming. Additionally, the integration of Bluetooth controllers and external input devices into the system enhances operator-driven interactions, making it possible to adjust playback in response to real-time production needs.

Although the subject matter disclosed herein is generally described with reference to TV and/or film production, the concepts and technologies presented are not so limited. The ability to simulate and dynamically control device interfaces in real-time has broad applications beyond entertainment, including interactive training simulations, live event productions, user experience testing, augmented reality applications, and emergency response training. The system’s capacity for seamless remote control, real-time feedback, and dynamic content adjustment may be leveraged in any field that needs responsive digital simulations, making it a versatile tool for various professional and commercial applications.

The subject matter of the present disclosure will now be described more fully hereinafter with reference to the accompanying drawings, which form a part hereof, and which show, by way of illustration, specific exemplary embodiments. An embodiment or implementation described herein as “exemplary” is not to be construed as preferred or advantageous, for example, over other embodiments or implementations; rather, it is intended to reflect or indicate that the embodiment(s) is/are “example” embodiment(s). Subject matter may be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof. The following detailed description is, therefore, not intended to be taken in a limiting sense.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” as used herein does not necessarily refer to a different embodiment. It is intended, for example, that claimed subject matter include combinations of exemplary embodiments in whole or in part.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

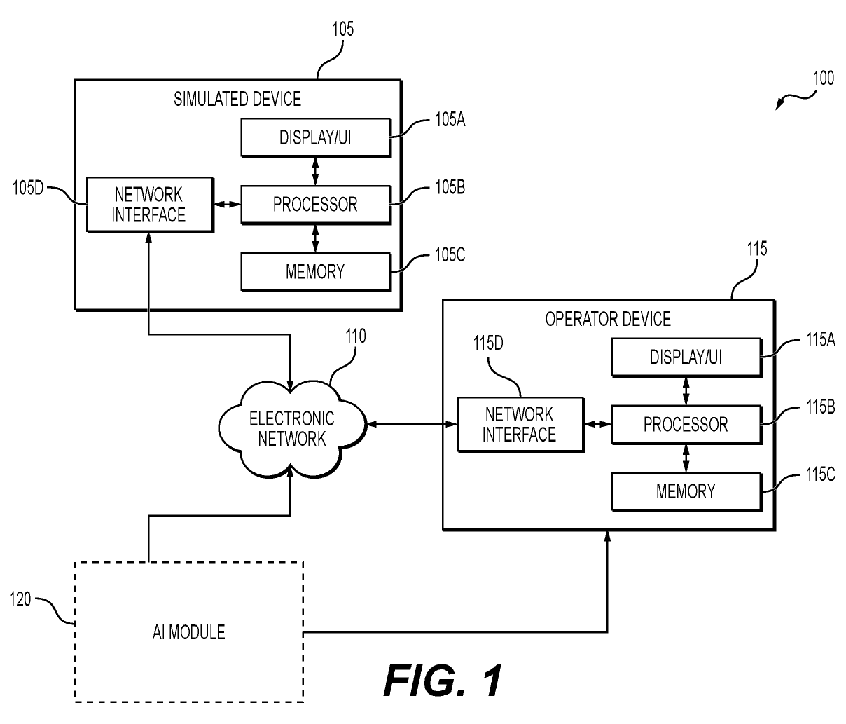

FIG. 1 depicts an exemplary block diagram of a computer system 100 (“system”) supporting a device simulation platform used in media production. The system 100 may include a simulated device 105, an electronic network 110, an operator device 115, and an optional AI module 120.

The simulated device 105 represents the user device upon which the simulation is performed, serving as the core component that mimics the behavior of a real device for on-set media production. The simulated device 105 may include a display/user interface (UI) 105A, a processor 105B, a memory 105C, and/or a network interface 105D. The simulated device 105 may be a personal computer (PC), a tablet PC, a set-top box (STB), a television (TV), a smart TV, a gaming console, a personal digital assistant (PDA), a mobile device, a palmtop computer, a laptop computer, a desktop computer, smart watch, etc. For simplicity purposes, the remaining disclosure described herein is described with reference to a simulated mobile device, e.g., such as a smart phone. However, it is important to note that such a designation is not intended to be limiting and, as indicated above, the simulated device may be one of a variety of different electronic devices.

The simulated device 105 may execute, by the processor 105B, an operating system (O/S) and at least one application (each stored in memory 105C). In an aspect, the application may be a proprietary software application that emulates a smartphone environment, including system applications, incoming and outgoing communications, and interactive screen elements. Unlike traditional mobile devices reliant on external cellular networks, the simulated device 105 operates within a controlled, script-driven environment, enabling precise manipulation of displayed content in real time, e.g., by operator device 115. This ensures that actors may engage with dynamic phone interactions that seamlessly align with scene specifications without relying on real-world mobile connectivity.

The display/UI 105A may be a touch screen or a display with other input systems (e.g., mouse, keyboard, etc.). The display/UI 105A may be the primary graphical interface of the simulated device 105, allowing users to interact with a visually authentic representation of a smartphone or other user device. It replicates the appearance and functionality of a conventional mobile operating system, including home screens, application layouts, notifications, message interfaces, and the like. In an aspect, the display/UI 105A may be fully customizable, with the ability to dynamically adjust based on operator commands, predefined script cues, or even AI-driven automation. The processor 105B, while executing the application, may receive user inputs from the display/UI 105A, and perform actions or functions in accordance with the application.

Processor 105B may be responsible for executing the software logic that drives the simulated environment on the simulated device 105. More particularly, processor 105B manages real-time graphical rendering, processing of operator-triggered commands, and execution of scripted interactions. The processor 105B ensures smooth performance even in complex scenarios, such as handling multiple concurrent events (e.g., a call while an on-screen message notification appears) or responding instantaneously to input from an external controller. In an aspect, given the time-sensitive nature of film production, the processor may be optimized for low-latency execution, ensuring that actor interactions, simulated system responses, and operator-controlled modifications are synchronized precisely with the scene’s timing.

Memory 105C may act as the storage repository for the simulated device 105, holding all necessary assets, configuration data, and preloaded scene content. This may include customized contact lists, stored text conversations, simulated application icons, wallpapers, and call histories, ensuring that every interaction remains consistent across multiple takes. Additionally, the memory 105C may be adaptable, allowing for on-the-fly updates in response to last-minute script changes. By maintaining a structured and customizable data set, the simulated device may replicate specific mobile environments accurately while giving production teams full control over visual and interactive elements.

Network interface 105D may facilitate two-way communication between the simulated device 105 and an operator device 115 through an electronic network 110, e.g., such as Wi-Fi, Bluetooth, or the Open Sound Control (OSC) protocol. This interface allows for real-time command execution, enabling the operator to remotely trigger interactions, including incoming calls, text messages, application interactions, screen updates, and the like. In an aspect, beyond sending commands, the network interface 105D may also support feedback transmission, allowing the operator to receive confirmation that an event was successfully executed on the simulated device. This two-way communication may ensure instantaneous control and monitoring, removing the need for direct on-device intervention and enabling seamless synchronization between operator-driven actions and on-screen mobile interactions.

In an aspect, a software application that simulates a mobile device interface on simulated device 105, and that operates independently of a native OS, may leverage one or more of display/UI 105A, processor 105B, memory 105C, and/or network interface 105D. Additionally or alternatively, the software application may leverage one or more sensors including an accelerometer, a gyroscope, a magnetometer, and a global positioning system (GPS). This simulation may be configured to provide a flexible and legally compliant solution for on-set media production, avoiding reliance on proprietary mobile operating system elements while enabling full control over the user interface and device behavior. The software may further be configured to replicate essential smartphone functionalities, including incoming calls, text messages, application interactions, and real-time UI adjustments, in a manner that appears realistic when viewed on-screen. To achieve this level of interactivity and customization, system 100 may be built within a video game engine, which allows for dynamic UI modifications, real-time rendering, and seamless animation control. Unlike traditional mobile emulators that may simply mirror existing OS behaviors, the game engine-based approach provides a modular and scriptable environment, enabling on-the-fly updates to UI components and scripted interactions that may be triggered manually by an operator or automatically by AI-driven logic. This level of adaptability ensures that the simulated mobile device may reflect real-time changes dictated by the script, production needs, or actor interactions, without relying on extensive pre-programming.

In an aspect, the software application may include a comprehensive user interface framework that replicates mobile OS elements in a customizable and production-friendly manner. This may involve creating simulated home screens, application interfaces, notification banners, message threads, incoming call overlays, and customizable wallpapers, all of which may be modified to align with the storyline and visual specifications of the production. In an aspect, the UI may be designed with flexible elements that allow for adjustments in time, date, screen brightness, and visual effects such as color correction, ensuring that the content displayed on-screen is optimized for different filming conditions. Furthermore, in another aspect, interactive components such as scrollable message threads, dynamic keyboard input simulations, and application switching animations may be implemented to enhance realism and provide a seamless on-screen experience.

The operator device 115 may serve as the control hub for the video playback operator to manage the simulated device 105 during media production. Similar to simulated device 105, operator device 115 may include a display/UI 115A, a processor 115B, a memory 115C, and/or a network interface 115D. The operator device 115 device allows for real-time adjustments, cue management, and dynamic content control, ensuring that the simulated device 105 responds accurately to scene specifications. The operator device 115 may enable interaction with the simulated device 105 and, by providing a high level of control and flexibility, the operator device 105 may ensure that on-screen interactions appear natural and synchronized with actor performances, while also allowing for instantaneous modifications if a scene deviates from the planned script.

Display/UI 115A includes the graphical control interface presented to the video playback operator, allowing the operator to monitor and control all aspects of the simulated environment on the simulated device 105. Through this interface, the operator can trigger specific events, such as incoming calls, messages, and screen manipulations, and adjust settings like brightness, wallpaper, or UI layout. The display/UI 115A may be designed to provide real-time feedback on the status of the simulated device 105. For example, if an operator sends a command to simulate an incoming call, the display/UI 115A may display the current state of the simulated device 105, ensuring synchronization between operator commands and on-screen actions. The processor 115B may be responsible for handling command execution, processing operator inputs, and ensuring real-time synchronization between the operator device and the simulated device 105. This processing unit may enable low-latency communication, ensuring that when an operator triggers an event, the response on the simulated device may be substantially immediate and precisely timed to align with the scene. The memory 115C may serve as the storage repository for the operator device 115, containing pre-configured cues, scene-specific content, and system settings necessary for playback control. The network interface 115D may facilitate the real-time exchange of data between the operator device and the simulated device 105 through electronic network 110.

In an aspect, data exchange between the simulated device 105 and the operator device 115 may be enabled to allow operators to send commands to the simulated device 105 while receiving real-time feedback confirming the execution of those commands. To achieve the foregoing, the system 100 may establish a communication protocol (e.g. Wi-Fi, Bluetooth, etc.) via electronic network 110 that allows for low-latency transmission of commands between the operator’s interface and the mobile simulation. This wireless connectivity ensures that an operator, positioned off-screen, may remotely trigger mobile events without needing to physically interact with the on-screen device. Additionally, the feedback mechanism may allow for error detection and correction, ensuring that if a command fails to execute due to network interference or system lag, the operator can promptly reissue the command or take corrective action.

In an aspect, for efficient command processing and response tracking, the system may implement structure data types that define how information is exchanged between devices. These data types may include string values (e.g., for handling textual information such as contact names, message content, caller IDs, etc.), Boolean values (e.g., for managing binary operations, such as toggling call status or determining whether an app is open or closed, etc.), integer values (e.g., for representing numerical data such as timestamps, volume levels, and script cue identifiers, etc.), and/or float values (e.g., for controlling real-time parameters like animation timing and screen brightness). By leveraging OSC and a structured communication framework, the system may ensure that every operator-issued command is not only transmitted in real time, but also confirmed and adjusted dynamically as needed

AI module 120 may include an optional enhancement to the system 100, introducing an AI-driven automation layer that may dynamically adjust the content displayed on the simulated device 105 based on script analysis, scene progression, and/or user behavior. While some implementations primarily rely on manual control by the operator device 115, the AI module 120 may streamline workflow, improve real-time adaptability, and reduce operator workflow by making intelligent, context-aware decisions. More particularly, by leveraging machine-learning models trained on script patterns, production cues, and actor interactions, the AI module has the potential to optimize mobile content display, ensuring that the AI module aligns with the evolving needs of the production. In an aspect, the AI module 120 may be configured to dynamically analyze script cues to determine expected device behavior. By parsing the script, the AI module 120 may extract relevant contextual elements, such as when an incoming call should appear, what message content should be displayed, or which contact name should be associated with a scene-specific conversation. This analysis may allow the AI module to anticipate and preconfigure device interactions, eliminating the need for operators to manually adjust these details in real time. Additionally, the AI module 120 may detect potential inconsistencies between the script and live production, making automated adjustments when necessary to maintain narrative coherence. In an aspect, beyond script analysis, the AI module 120 may also automatically generate content updates based on contextual changes within the scene. For instance, if the director alters a scene mid-shoot, the AI module 120 may dynamically modify text message content, adjust caller IDs, or update app interactions to reflect these changes, ensuring that the simulated device remains synchronized with the revised production direction. The AI module 120 may also predict logical sequences of events, such as triggering a follow-up message after a character reads a text or adjusts timestamps dynamically to maintain realism. Additionally, in some aspects, the AI module 120 may assist operators in real-time decision-making by suggesting appropriate cues based on actor performance and deviations from the script. For instance, if an actor improvises or misses a cue, the AI module 120 may detect this deviation and recommend an appropriate on-screen response – such as delaying an incoming call or modifying a displayed message to keep the scene flowing naturally. This intelligent adaptability ensures that even unscripted variations in a performance may be seamlessly incorporated into the simulated mobile interactions, making the production process more flexible and resilient.

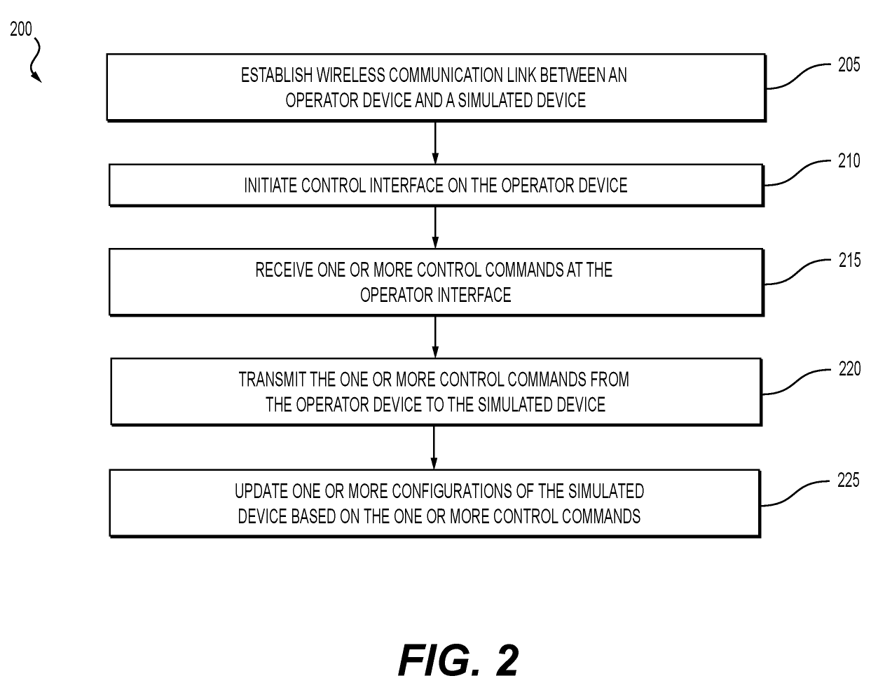

Referring now to FIG. 2, an exemplary workflow 200 is described for utilizing an operator interface to manipulate one or more characteristics (e.g., audio characteristics, visual characteristics, etc.) of a simulated device. Aspects of the exemplary workflow 200 may be performed in accordance with some or all components described in FIG. 1.

At step 205, a wireless communication link may be established between an operator device 115 and a simulated device 105. This communication may be facilitated through OSC over Bluetooth, Wi-Fi network or local area network (LAN), allowing for low-latency, bidirectional data exchange between the operator’s interface and the simulated device 105. The utilization of Bluetooth or Wi-Fi as a communication medium allows the system 100 to function without reliance on cellular networks, which may introduce connection inconsistencies, limited range, or latency issues in on-set environments (e.g., if the set is not proximal to a cell tower and/or located is positioned in a dead zone within a cel network). By leveraging OSC, the system 100 enables operators to issue precise, frame-accurate commands to the simulated device 105. This ensures that mobile content remains synchronized with the actor’s performance and the scene’s timing specifications, reducing the likelihood of playback delays or errors.

At step 210, a real-time monitoring and control interface (“operator interface”) may be initiated on the operator device 115. This operator interface may visually represent the current state of the simulated device 105 and may ensure that the operator has continuous oversight of the mobile interactions occurring on-screen, eliminating the need for direct visual confirmation of the physical device while improving response time and precision.

In an aspect, the operator interface may dynamically update to reflect changes occurring on the simulated device 105. For instance, the operator interface may present a real-time representation of the device state, including active applications, on-screen notifications, and system settings (e.g., brightness, volume levels, etc.). This ensures that the operator can instantly verify whether a triggered event (e.g., such as an incoming call, text message, UI modification, etc.) is accurately displayed. In an aspect, the operator interface may display an NDI-powered live feed of the simulated device’s 105 screen, enabling the operator to see exactly what the actor sees on the simulated device 105. In some aspects, each issued command may appear on the operator interface along with a visual confirmation of its success or failure. For instance, if an operator triggers an incoming call, the interface may update to show whether the call has started ringing, whether the call was answered or rejected, and if necessary, whether a corrective action is needed. In some aspects, the operator interface may include a chronological list of events, allowing the operator to, for example, track past interactions, review executed commands, and compare timing consistency between takes. This may be particularly useful for maintaining screen continuity across multiple shots. In some aspects, if the system detects missed cues or script deviations, the monitoring interface may provide one or more manual override options that allow the operator to quickly trigger alternate playback sequences or adjust on-screen content without disrupting the scene.

At step 215, one or more control commands may be received at the operator device 115 via interactions with the operator interface. These control commands may allow for real-time manipulation of on-screen interactions of the simulated device 105, ensuring that simulated device 105 activity aligns with the demands of a film or TV production. Non-limiting control commands may include triggering an incoming call, sending a text message, modifying a user interface element, and/or executing a predefined playback sequence. For instance, in one example related to triggering an incoming call, the operator may remotely initiate a simulated phone call on the simulated device 105, specifying details such as the caller ID, contact name, phone number, ringtone behavior, and call duration. This ensures that the actor may interact with the simulated device 105 in a way that appears natural on camera while maintaining precise timing control. If the actor misses a cue, the operator may adjust or re-trigger the call in real time without disrupting the scene. In another example, the system may allow the operator to simulate an incoming text message, complete with customized sender information, message content, and timestamp adjustments. The message may be part of a scripted sequence or may be adjusted dynamically if changes occur on set. Additionally, if the actor responds on-screen, the system may modify the text display to ensure the interaction remains consistent with the script. If a scene relies on a transition from one UI state to another (e.g., switching between applications, opening notifications, or displaying a contact list), the operator may execute these changes remotely and in real time. In yet another example related to executing a predefined playback sequence, the system also supports scripted playback sequences, allowing operators to trigger a chain of events in a structured manner. For example, a pre-programmed sequence may include an incoming call followed by a text message, then an application notification, all occurring in a controlled timeline. If the production team needs modifications, the operator may adjust playback speed, skip steps, or reset sequences instantly, ensuring that on-screen interactions are precisely aligned with the scene’s timing and flow.

Additionally or alternatively to the foregoing, the operator may also adjust playback settings in real-time, ensuring that the simulated device 105 remains visually and functionally aligned with production needs. More particularly, the operator may control various UI elements, such as wallpaper changes, application icons, screen brightness, UI animations, and touch interaction responses. This allows the simulated device 105 to appear as a natural extension of the actor’s performance, ensuring that all visual elements align with the storyline’s specifications. For instance, in one aspect, since film sets often involve varying light intensities and color temperatures, the operator may be able to modify brightness levels dynamically to prevent overexposure, glare, or screen reflections that may impact on-camera visibility. In another aspect, the system 100 may allow for real-time color correction adjustments, enabling the operator to fine-tune the screen’s color balance, contrast, and saturation to match the director’s vision and/or the overall color grading of the scene. Without such adjustments, color inconsistencies may necessitate extensive post-production editing or reshoots. In an aspect, beyond color and brightness modifications, the system 100 may also provide UI layout customization, allowing the operator to alter screen elements, application positioning, text sizes, and notification placements in real time. This ensures that the display/UI 105A of the simulated device 105 remains legible and visually appealing on-camera, regardless of device orientation, camera angle, or shot composition. For example, if an actor holds the phone at an unintended angle, the operator may need to adjust the UI elements to ensure that important on-screen content remains visible to the camera. In an aspect, the system may further support content timing adjustments, enabling operators to modify the delivery timing of text messages, call notifications, and application interactions to synchronize with actor performance and scene pacing. For instance, if an actor delays responding to a text message, the operator may hold or resend the message to ensure the interaction remains natural.

At step 220, upon receiving one or more control commands from the operator through the operator interface, the operator device 115 may transmit these commands via a wireless communication link (e.g., electronic network 110) to the simulated device 105. This transmission provides a low-latency, real-time exchange of instructions, enabling synchronization between the operator’s inputs and the simulated device’s 105 display/UI 105A. In an aspect, wireless communication may be facilitated through Wi-Fi, Bluetooth, or a network-based protocol such as OSC, thereby ensuring a reliable and responsive connection even in dynamic on-set environments. At step 225, one or more configurations on the simulated device 105 may be updated based on receipt of the transmitted commands. More particularly, the simulated device 105 may process the instructions to modify device characteristics (e.g., visuals displayed on the screen of the simulated device 105), thereby causing a visual effect to appear on the device’s screen in real time. The modification may include simulated incoming calls, text messages, application behaviors, wallpaper changes, or system notifications, depending on the received command.

In an aspect, real-time feedback may be received at the operator device 115 from the simulated device 105. This feedback may confirm whether a transmitted control command has been successfully executed on the simulated device 105. More particularly, this feature ensures that every interaction – whether it be an incoming call, text message, UI modification, playback sequence, etc. – is not only triggered but also accurately displayed and synchronized with the scene’s timing specifications. In an aspect, the feedback data received at the operator device 115 may include structured responses that may confirm command execution. For instance, if the operator triggers an incoming call, the system 100 may send back a confirmation indicating whether the call is currently ringing on the simulated device 105. In an aspect, if the system 100 detects that a command failed to execute (e.g., as a result of network latency, device state conflicts, actor interaction deviations, etc.), the operator may receive an alert, which may allow them to resend the command, modify its parameters, or trigger a corrective action. In an aspect, the feedback system may also track key device states, such as whether the screen is locked or unlocked, brightness levels, active applications, UI responsiveness, etc. This data may enable the operator to anticipate potential issues and adjust playback accordingly. In an aspect, each interaction may be logged with a timestamp and execution status, providing a record of command execution accuracy. This may be particularly useful for multi-take scenes, where the operator may need to reference previous playback states to ensure consistency across different shots.

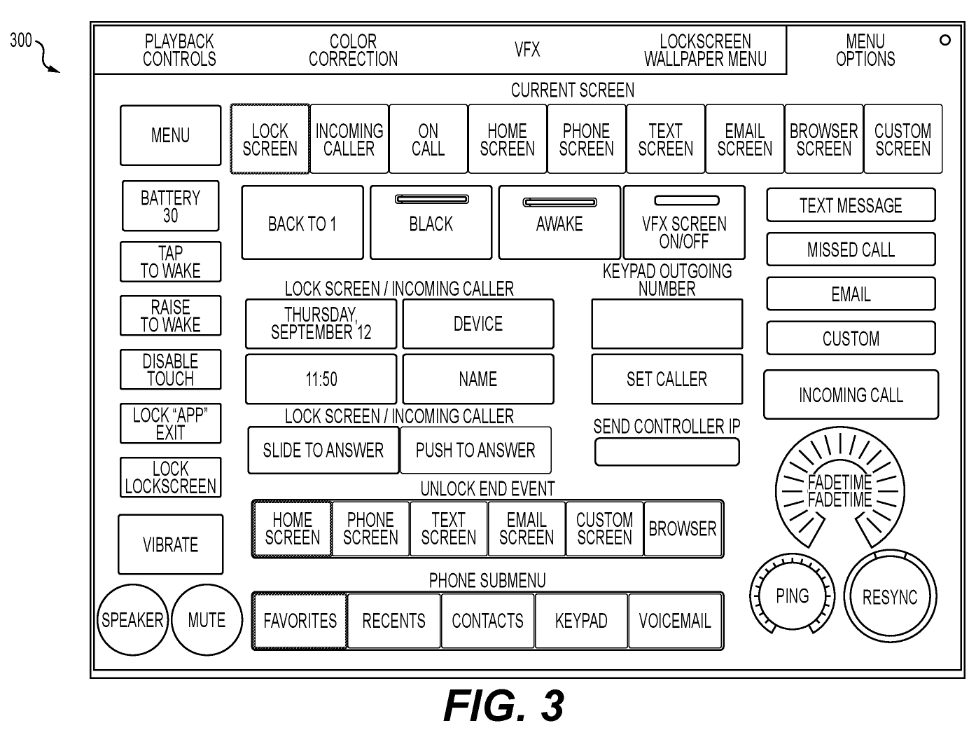

FIGS. 3-9 provide illustrations of exemplary operator interfaces 300-900. These interface designs are non-limiting, and those skilled in the art will understand that other operator interfaces may include more, less, and/or different control options, organized in a similar or different fashion, than what is illustrated in the FIGS. 3-9 and described herein. Additionally, features of the operator interfaces 300-900 may be identified and/or described in a subset of figures, but may not be elaborated upon in other the description of subsequent similar interfaces. Additionally, some features of the operator interfaces 300-900 may not be explicitly elaborated upon herein, but may be readily understandable to those skilled in the art.

FIG. 3 provides an illustration of an exemplary operator interface 300 for controlling a simulated device 105 in a media production environment. The operator interface 300 may be structured with a variety of interactive elements that allow an operator to manage on-screen mobile interactions dynamically. At the top of operator interface 300, navigation tabs such as “Playback Controls,” “Color Correction, “VFX,” “Lockscreen Wallpaper Menu,” and “Menu Options” may enable an operator to switch between different functions for maintaining the visual and interactive aspects of the simulated device 105. Below the navigation tabs, the operator has access to multiple screen states that allow for quick transitions between different simulated phone environments, including “lock screen,” “incoming call,” “on-call,” “home screen,” “phone screen,” “text screen,” “email screen,” and “browser screen.” Below this, on the right side of operator interface 300, buttons labeled “text message,” “missed call,” “email,” “custom,” and “incoming call” enable an operator to trigger specific mobile interactions in real-time, aligning with scripted events or adjusting dynamically to actor performance. On the left side of the operator interface 300, several control buttons such as “Tap to wake,” “Raise to wake,” “Disable touch,” “Lock ‘app’ exit,” and “Lock LockScreen” provide additional fine-tuned control over the simulated device’s behavior. The battery level display and the “Vibrate,” “Speaker,” and “Mute” controls further contribute to an immersive and realistic mobile simulation. The bottom section includes a sub-menu for phone functions, allowing the operator to manage elements like “Favorites,” “Recents,” “Contacts,” “Keypad,” and “Voicemail.” Additionally, the presence of “Ping” and “Resync” support real-time monitoring and synchronization, ensuring that all device interactions are correctly executed and aligned with the media production’s needs. Other options are present in operator interface 300 that are not explicitly described here.

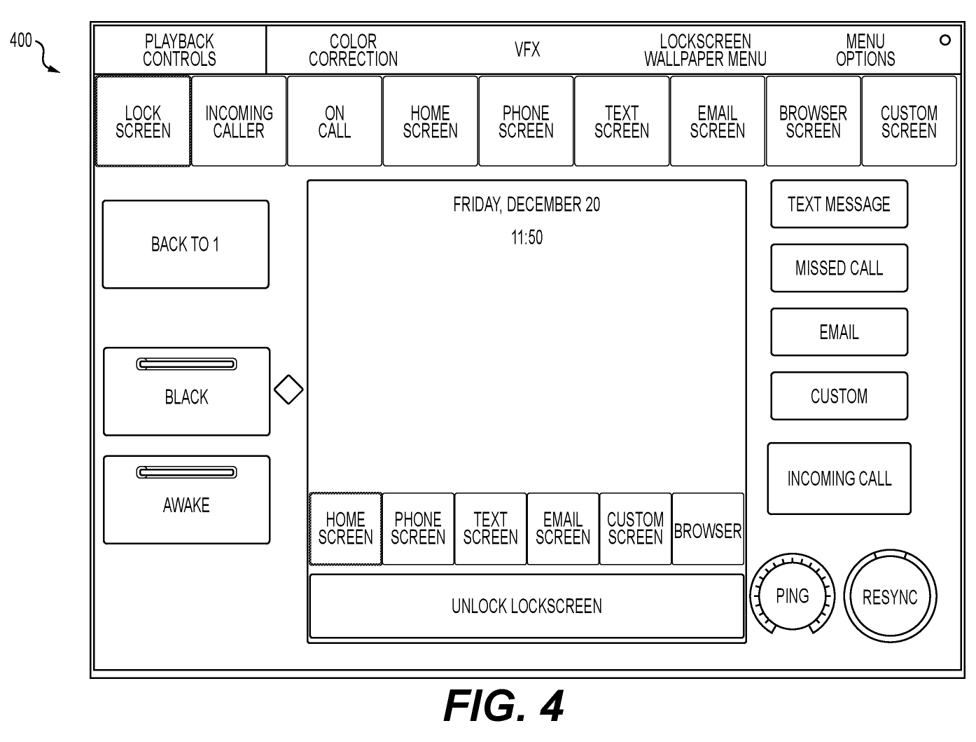

FIG. 4 provides an illustration of an exemplary operator interface 400 for controlling aspects of a lock screen on a simulated device 105 in a media production environment. A central section of operator interface 400 prominently features a large, simulated device screen, currently displaying a lock screen with a date and time interface. Surrounding this central section are interactive controls that allow the operator to modify the state of the simulated device. On the left side of the operator interface 400, a panel of buttons labeled “Back to 1,” “BLACK,” and “AWAKE” are provided, which control different screen states, allowing the operator to reset the device, transition to a black screen, or wake the simulated device as needed. The presence of sliders and toggles enables the operator to provide adjustable brightness, opacity, or transition effects. On the right side of the operator interface 400, action triggers such as “Text Message,” “Missed Call,” “Email,” “Custom,” and “Incoming Call,” allowing the operator to generate simulated notifications or interactions on the device screen. These controls may be leveraged to ensure that scripted interactions occur at the right time during filming, adding realism to scenes corresponding to mobile usage. At the bottom of the operator interface 400, additional navigation options allow the operator to switch between different simulated phone screens, including “Home Screen,” “Phone Screen,” “Text Screen,” “Email Screen,” “Custom Screen,” and “Browser.”

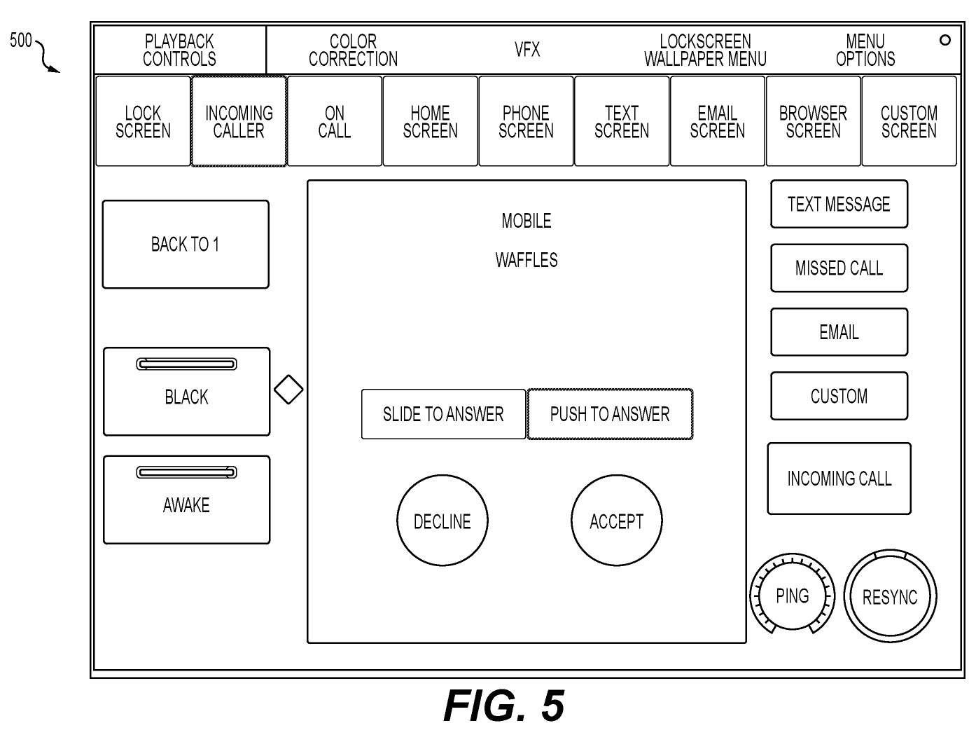

FIG. 5 provides an illustration of an exemplary operator interface 500 for an incoming call simulation on a simulated device 105 in a media production environment. This feature enables an operator to trigger, manipulate, and synchronize incoming call events on the simulated device during filming. The central section of operator interface 500 includes a simulated phone screen that displays an incoming call from a contact labeled “Waffles.” The call screen provides multiple response options, including a “slide to answer” button, a “push to answer” button, as well as “Decline” and “Accept” buttons, offering flexible ways to simulate actor-driven or operator-controlled interactions.

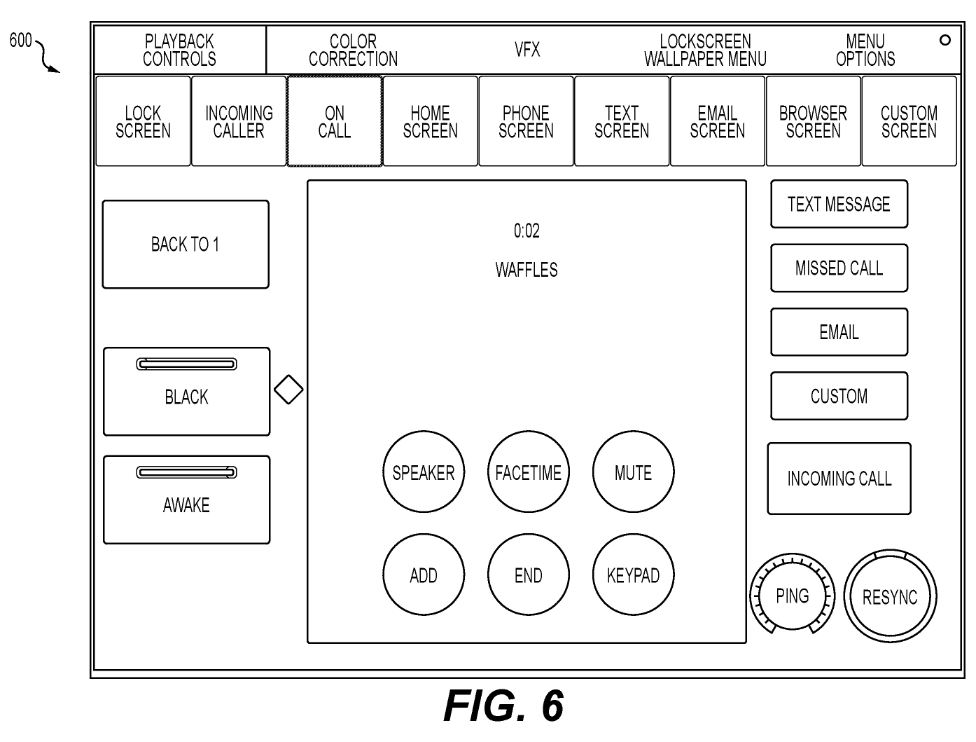

FIG. 6 provides an illustration of an exemplary operator interface 600 for controlling a simulated device 105 during an active call in a media production environment. The “On Call” tab is highlighted in the top navigation panel, indicating that the simulated device is currently engaged in a call with a contact labeled “Waffles.” A call timer at the top of the simulated screen (showing 00:002) indicates that the conversation is in progress, allowing the operator to simulate real-time call behavior in a controller manner. The central section features a realistic call interface with several interactive controls that mimic a real phone’s calling options. The operator may enable or disable Speaker Mode, initiate a Facetime simulation, activate the Mute function, access a Keypad, or Add another call participant, closely replicating an actual mobile call experience. The “End” button, highlighted in red, provides the operator with the ability to terminate the call at any moment, ensuring that scripted or real-time adjustments may be made seamlessly.

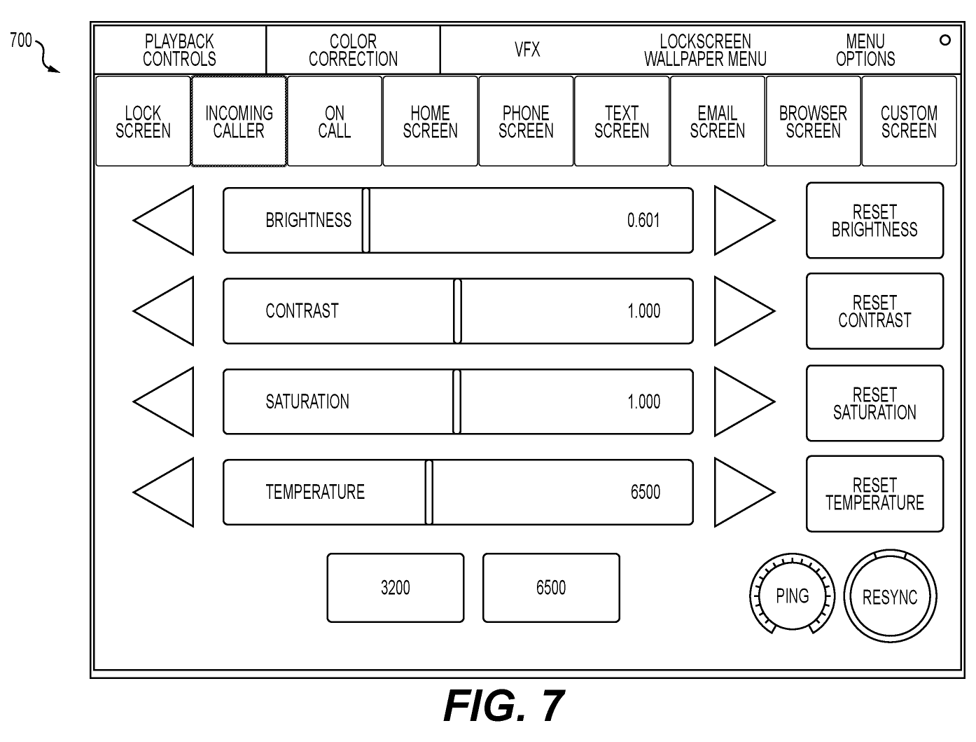

FIG. 7 provides an illustration of an exemplary operator interface 700 focused on correction controls for a simulated device 105 in a media production environment. Near the top of operator interface 700, the “Incoming Caller” tab is highlighted, meaning that these adjustments may be applied while the simulated device is in an incoming call state, allowing for real-time changes in display properties. In the center of the operator interface 700, four key adjustable settings are displayed: brightness, contrast, saturation, and color temperature. Manipulation of these settings indicate that the system may allow operators to fine-tune the visual appearance of the simulated device to ensure it looks realistic and natural on camera. On the right side of the interface, dedicated reset buttons may enable an operator to restore default settings, ensuring quick recovery if adjustments do not align with production needs.

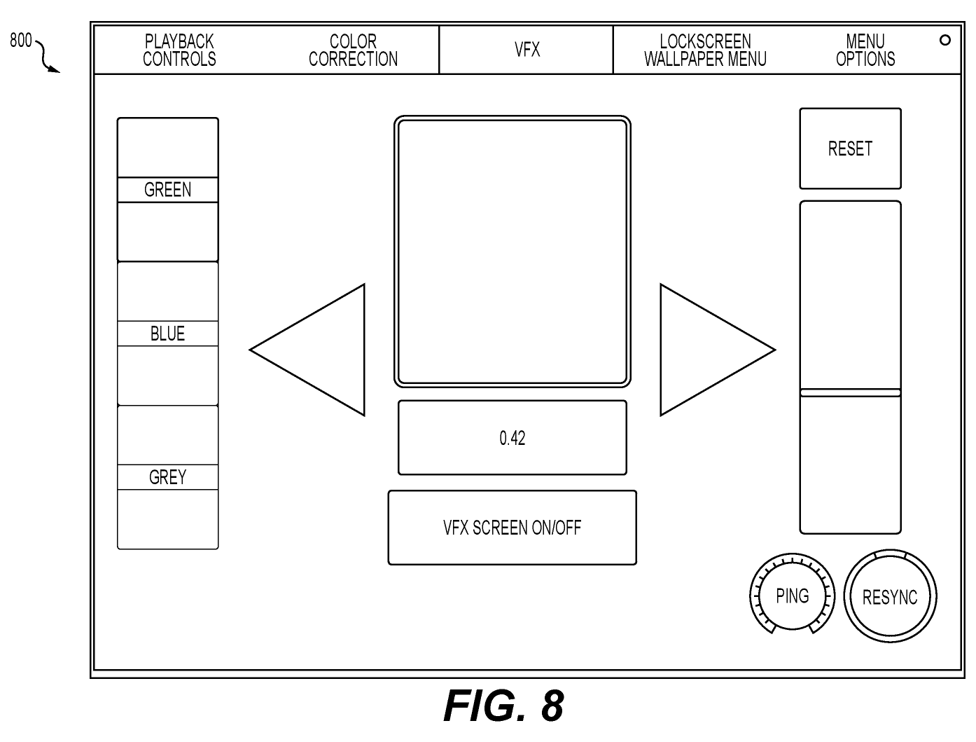

FIG. 8 provides an illustration of an exemplary operator interface 800 focused on visual effects (VFX) screen controls for a simulated device 105 in a media production environment. Operator interface 800 is designed to manage on-screen green screen and other visual effects settings, allowing for post-production compositing and real-time color adjustments. The central section of operator interface 800 features a color-adjustable display indicating that the simulated device 105 is in a mode commonly used in post-production for replacing screen content with digital effects or overlays. The operator may switch between different preset colors, including green, blue, and grey, using the selection buttons on the left. In some aspects, the operator may be able to adjust the intensity or transparency of the VFX screen, e.g., by controlling the brightness or opacity of the selected color. Large left and right arrow buttons adjacent to the screen display may allow for fine-tuned adjustments to these settings. At the bottom of the operator interface 800, a “VFX screen on/off” button may enable the operator to toggle the effect on or off, providing quick switching between normal and VFX screen modes as needed during a scene.

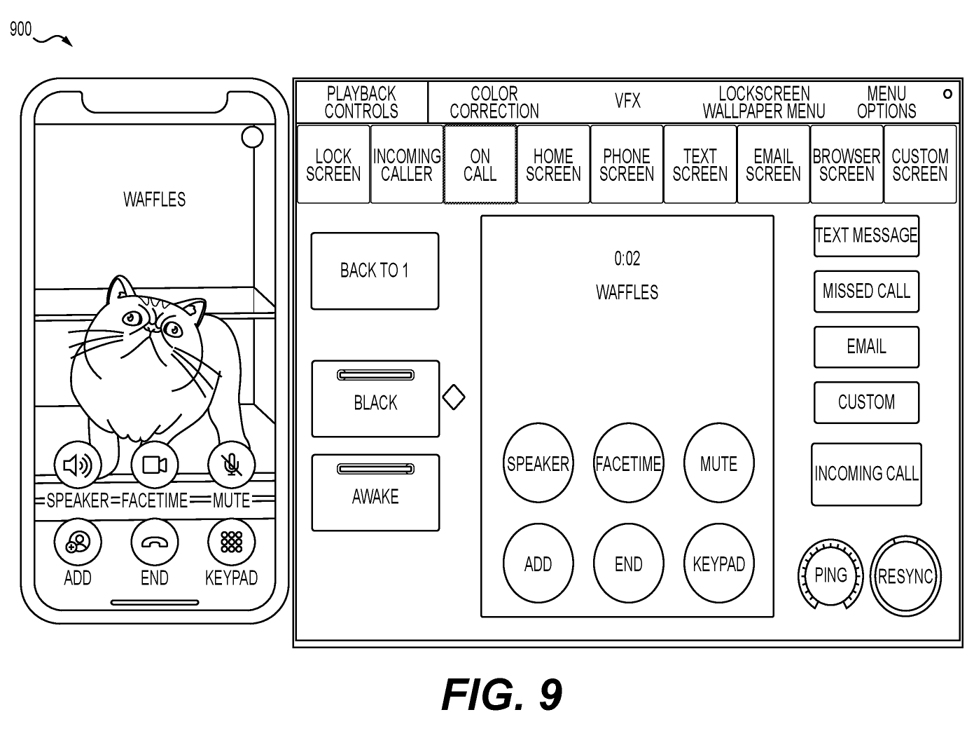

FIG. 9 provides an illustration of an exemplary operator interface 900 that includes a live feed of the simulated device’s 105 screen, enabling the operator to see exactly what the actor sees on the simulated device 105. In this instance, the operator may manage an active call on the simulated device 105 (e.g., as described above with reference to FIG. 6) and may visualize, in substantially real-time, how the manipulations of the control settings on the operator interface 900 directly affect the screen of the simulated device 105.

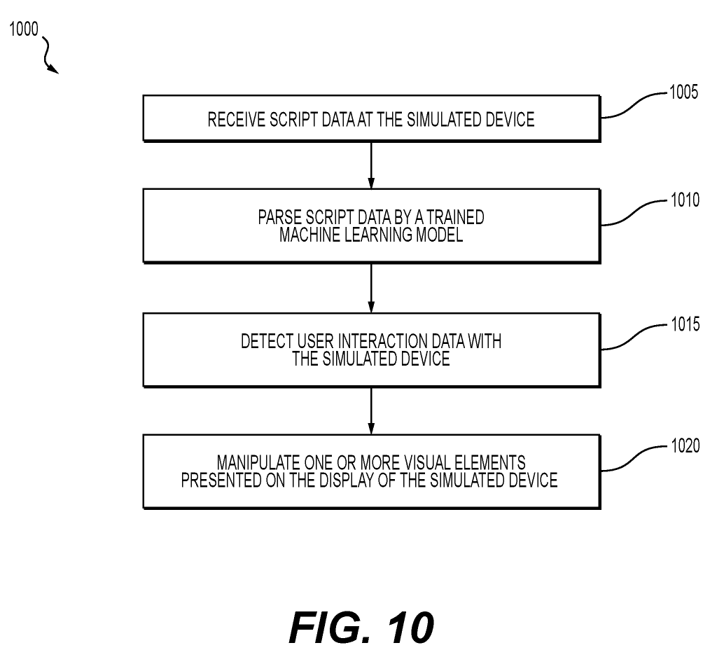

Referring now to FIG. 10, an exemplary workflow 1000 is described for using one or more trained machine-learning models to manipulate visual characteristics on a simulated device 105. Aspects of the exemplary workflow 1000 may be performed in accordance with some or all components described in FIG. 1.

At step 1005, script data associated with a production scene may be received at the simulated device 105 (e.g., from a user, data source, etc.). This script data may be in a digital format, such as a structured text file, screenplay document, etc. The received script data may include details of device interactions, such as scripted incoming and outgoing calls, text messages, notifications, application behaviors, display modifications, etc., all of which are important to maintaining realism and continuity in the production. In some aspects, the script may also include metadata, timestamps, or cue markers, allowing for the synchronization between the actor’s performance, the device’s interactions, and other on-set elements.

At step 1010, the script data may be parsed, e.g., by a trained machine-learning model associated with the AI module, to identify key segments where mobile device actions are needed. This analysis may enable the device to anticipate and prepare the appropriate visual and functional elements that may be displayed during filming. In an aspect, the parsing process may be performed using a rule-based algorithm, a trained machine-learning model, some combination thereof, etc., capable of interpreting both structured and unstructured script elements. The parsing process may reveal actionable production cues that indicate when and how specific on-screen events should occur. These cues may include, for example, directives such as “the phone rings,” “a message appears from ‘Mom’,” or “the character opens the social media application,” and, in some circumstances, may also include metadata like timing, scene number, character names, or emotional tone. By analyzing sentence structure, stage directions, dialogue timing, and/or contextual keywords, the system 100 may accurately classify and timestamp these cues. Once identified, the cues may be mapped to specific device behaviors and visual elements that must be rendered or triggered during the scene, enabling dynamic synchronization between the script and the simulated device’s 105 visual output.

At step 1015, user interaction data with the simulated device 105 may be detected. The types of user interaction data may include, but are not limited to, touchscreen input (e.g., taps, swipes, long-presses, etc.), hardware button presses, accelerometer or gyroscope-triggered movements, proximity sensor activations, or other physical or behavioral signals indicative of user engagement with the simulated device 105. By capturing these interactions in real time, the system 100 may determine how and when a user (e.g., an actor) is attempting to perform specific on-screen actions, such as answering a call, typing a message, or navigating through an application interface. In an aspect, this monitoring may occur locally on the device or, alternatively, may be relayed to a remote operator interface for additional contextual awareness.

At step 1020, one or more visual elements presented on the display of the simulated device 105 may be manipulated based on the previously identified cues from the production script and/or the user interaction data. These visual elements may include, but are not limited to, incoming call screens, text message threads, application interfaces, lock screen notifications, photo galleries, or any other UI components typically found on a mobile operating system. In an aspect, the manipulation may involve initiating, modifying, rearranging, or removing visual content on the screen to reflect the intended narrative sequence. For example, if a cue indicates an incoming call from a specific contact, and the actor initiates a corresponding gesture (e.g., lifts the phone to their ear), the system 100 may display an active call interface and trigger supporting animations or sound cues. This manipulation may be dynamic by responding fluidly to changes in the actor’s behavior or real-time adjustments to the script, ensuring continuity even in the presence of improvisation or production-day alterations.

Provided below are a plurality of non-limiting, exemplary scenarios that illustrate the practical implementation of the concepts described herein.

In a first exemplary scenario, a scene may include an actor, playing a detective, who is supposed to receive a crucial phone call revealing new case information. Instead of relying on a pre-recorded ringtone or an actual phone call, the system may allow an off-screen operator to trigger the incoming call at the precise moment the actor reaches for the phone. The caller ID, ringtone behavior, and screen animation are all controlled remotely, ensuring that the timing aligns perfectly with the dramatic tension of the scene. If the director decides to delay the call to allow for a longer build-up, the operator may pause and re-trigger the event instantly without disrupting the flow of filming.

In a second exemplary scenario, a scene in a romantic comedy may involve a character nervously texting a love interest. The script dictates a back-and-forth exchange of messages, but if the actor stumbles on a line or delays interacting with the phone, the system may allow the operator to adjust the timing of the incoming text responses dynamically. Additionally, if the director requests a change in the dialogue mid-shoot, the operator may edit the text message content in real-time, updating the simulated conversation without resulting in a break in filming.

In a third exemplary scenario, a character in a horror movie is using their smartphone flashlight to explore a dark basement. However, the director notices that the screen brightness on the actor’s simulated device is too dim to be captured effectively on camera. Using the system’s remote brightness control, the operator may increase the screen illumination instantly, ensuring that the light source looks natural while maintaining the eerie atmosphere of the scene.

In a fourth exemplary scenario, a character may be reading breaking news updates on the smart phone. The system may be preloaded with multiple possible news headlines, and the operator may select the most relevant one based on real-time script developments. If the director wants the news update to reflect an evolving subplot, the operator may override the pre-set content and enter a custom breaking news banner on the fly, ensuring that the scene reflects the latest creative decisions.

In a fifth exemplary scenario, in a science fiction film, a hacker character may be shown manipulating multiple devices at once, including a smartphone, a tablet, and an on-screen projection. The system may enable the operator to synchronize interactions across all devices, ensuring that when the character types a command on the phone, the tablet and projection screen update accordingly. This may eliminate the need for extensive post-production effects, as the interactions may occur naturally during filming.

In a sixth exemplary scenario, in a court drama where a lawyer is supposed to receive an urgent text from a client, a trained model may pre-program the message sequence based on the script and automatically trigger the model at the correct moment without the need for an operator to intervene.

In general, any process discussed in this disclosure that is understood to be computer-implementable, such as the processes illustrated in FIGS. 2 and 10, may be performed by one or more processors of a computer system, such as computer system 100 described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer server. A processor may be a central processing unit (CPU), a graphics processing unit (GPU), or any suitable types of processing unit.

A computer system, such as computer system 100, may include one or more computing devices. If the one or more processors of the computer systems are implemented as a plurality of processors, the plurality of processors may be included in a single computing device or distributed among a plurality of computing devices. If the computer system 100 comprises a plurality of computing devices, the memory of the computer system 100 may include the respective memory of each computing device of the plurality of computing devices.

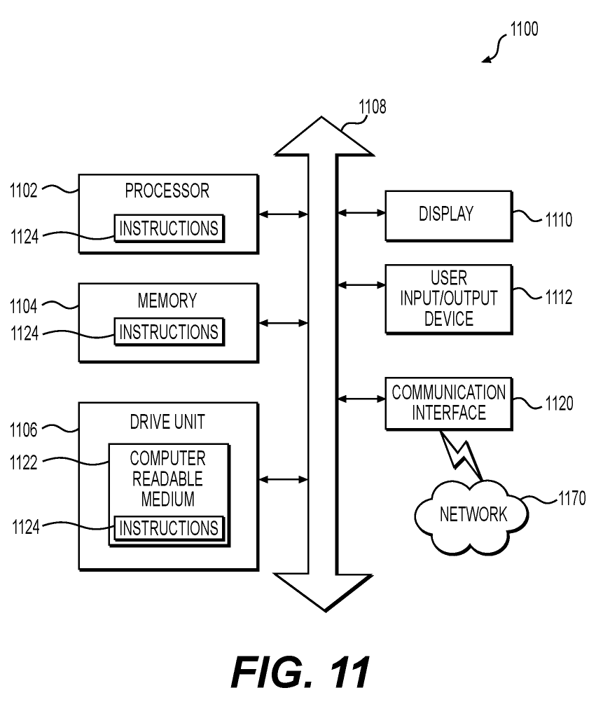

FIG. 11 is a simplified functional block diagram of a computer system 1100 that may be configured as a computing device for executing the process illustrated in FIGS. 2 and 10, according to exemplary embodiments of the present disclosure. FIG. 11 is a simplified functional block diagram of a computer that may be configured as the computer system 100 according to exemplary embodiments of the present disclosure. In various embodiments, any of the systems herein may be an assembly of hardware including, for example, a data communication interface 1120 for packet data communication. The platform also may include a central processing unit (“CPU”) or processor 1102, in the form of one or more processors, for executing program instructions. The platform may include an internal communication bus 1108, and a storage unit 1106 (such as ROM, HDD, SDD, etc.) that may store data on a computer readable medium 1122, although the system 1100 may receive programming and data via network communications via electronic network 1125 (e.g., voice, video, audio, images, or any other data over the electronic network 1125). The system 1100 may also have a memory 1104 (such as RAM) storing instructions 1124 for executing techniques presented herein, although the instructions 1124 may be stored temporarily or permanently within other modules of system 1100 (e.g., processor 1102 and/or computer readable medium 1122). The system 1100 also may include input and output devices 1112 and/or a display 1110 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

Other embodiments of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

In general, any process discussed in this disclosure that is understood to be performable by a computer may be performed by one or more processors. Such processes include, but are not limited to: the processes shown in FIGS. 2 and 10, and the associated language of the specification. The one or more processors may be configured to perform such processes by having access to instructions (computer-readable code) that, when executed by the one or more processors, cause the one or more processors to perform the processes. The one or more processors may be part of a computer system (e.g., one of the computer systems discussed above) that further includes a memory storing the instructions. The instructions also may be stored on a non-transitory computer-readable medium. The non-transitory computer-readable medium may be separate from any processor. Examples of non-transitory computer-readable media include solid-state memories, optical media, and magnetic media.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention needs more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method for controlling one or more characteristics of a simulated device, the computer-implemented method comprising operations including:
establishing, by one or more processors, a wireless communication link between an operator device and the simulated device, wherein the simulated device includes one or more characteristics corresponding to a configuration of the simulated device;
initiating, by the one or more processors, an operator interface on the operator device, wherein the operator interface is configured to control the one or more characteristics of the simulated device;
receiving, by the one or more processors, one or more control commands from an operator of the operator device at an operator interface;
transmitting, by the one or more processors and responsive to the receiving, the one or more control commands from the operator device to the simulated device via the wireless communication link; and
updating, by the one or more processors and responsive to the transmitting, one or more configurations of the simulated device based on the one or more control commands.

2. The computer-implemented method of claim 1, wherein the simulated device includes at least one of: a smart phone, a tablet, a laptop computer, a desktop computer, and a dedicated electronic display.

3. The computer-implemented method of claim 1, wherein the wireless communication link is established using an open sound control (OSC) protocol over a Wi-Fi network or a Bluetooth network.

4. The computer-implemented method of claim 1, wherein the one or more characteristics include one or more of: a visual characteristic of the simulated device, an audio characteristic of the simulated device, and a haptic characteristic of the simulated device.

5. The computer-implemented method of claim 1, wherein the one or more control commands comprise a command to: trigger a simulated call on the simulated device, display a simulated message on the simulated device, or modify one or more visual characteristics on the simulated device.

6. The computer-implemented method of claim 1, wherein the operator interface comprises a live feed of a display of the simulated device.

7. The computer-implemented method of claim 6, further comprising:
outputting, by the one or more processors, one or more transmission results on the live feed, wherein the one or more transmission results include one or more control commands results corresponding to transmission of the one or more control commands to the simulated device or one or more interaction results corresponding to a user interaction with the simulated device.

8. The computer-implemented method of claim 1, wherein the simulated device corresponds to two or more simulated devices, and wherein one or more characteristics of each of the two or more simulated devices is controllable by the operator interface of the operator device.

9. The computer-implemented method of claim 1, further comprising:
receiving, by the one or more processors, at the operator device, feedback from the simulated device, wherein the feedback provides a success indication corresponding to the transmitted one or more control commands.

10. The computer-implemented method of claim 9, further comprising:
initiating, by the one or more processors, one or more subsequent actions based on the received feedback.

11. A system for controlling one or more characteristics of a simulated device, comprising:
a memory including instructions; and
at least one processor configured to execute the instructions stored in the memory to perform operations comprising:
establishing a wireless communication link between an operator device and the simulated device, wherein the simulated device includes one or more characteristics corresponding to a configuration of the simulated device;
initiating an operator interface on the operator device, wherein the operator interface is configured to control the one or more characteristics of the simulated device;
receiving one or more control commands from an operator of the operator device at an operator interface;
transmitting, responsive to the receiving, the one or more control commands from the operator device to the simulated device via the wireless communication link; and
updating, responsive to the transmitting, one or more configurations of the simulated device based on the one or more control commands.

12. The system of claim 11, wherein the wireless communication link is established using an open sound control (OSC) protocol over a Wi-Fi network or a Bluetooth network.

13. The system of claim 11, wherein the one or more characteristics include one or more of: a visual characteristic of the simulated device, an audio characteristic of the simulated device, and a haptic characteristic of the simulated device.

14. The system of claim 11, wherein the one or more control commands comprise a command to: trigger a simulated call on the simulated device, display a simulated message on the simulated device, or modify one or more visual characteristics on the simulated device.

15. The system of claim 11, wherein the operator interface comprises a live feed of a display of the simulated device.

16. The system of claim 15, wherein the instructions are further executable by the at least one processor to perform operations comprising:
outputting one or more transmission results on the live feed, wherein the one or more transmission results include one or more control commands results corresponding to transmission of the one or more control commands to the simulated device or one or more interaction results corresponding to a user interaction with the simulated device.

17. The system of claim 11, wherein the simulated device corresponds to two or more simulated devices, and wherein one or more characteristics of each of the two or more simulated devices is controllable by the operator interface of the operator device.

18. The system of claim 11, wherein the instructions are further executable by the at least one processor to perform operations comprising:
receiving, at the operator device, feedback from the simulated device, wherein the feedback provides a success indication corresponding to the transmitted one or more control commands.

19. The system of claim 18, wherein the instructions are further executable by the at least one processor to perform operations comprising:
Initiating one or more subsequent actions based on the received feedback.

20. A non-transitory computer-readable medium storing computer-executable instructions which, when executed by a server in network communication with at least one database, cause the server to perform operations comprising:
establishing, by one or more processors, a wireless communication link between an operator device and the simulated device, wherein the simulated device includes one or more characteristics corresponding to a configuration of the simulated device;
initiating, by the one or more processors, an operator interface on the operator device, wherein the operator interface is configured to control the one or more characteristics of the simulated device;
receiving, by the one or more processors, one or more control commands from an operator of the operator device at an operator interface;
transmitting, by the one or more processors and responsive to the receiving, the one or more control commands from the operator device to the simulated device via the wireless communication link; and
updating, by the one or more processors and responsive to the transmitting, one or more configurations of the simulated device based on the one or more control commands.
